(19) United States
(12) Patent Application Publication
(10) Pub. No.: US 2023/0093165 A1
(43) Pub. Date: Mar. 23, 2023

(54) INFORMATION PROCESSING APPARATUS, INFORMATION PROCESSING METHOD, AND PROGRAM

(71) Applicant: SONY GROUP CORPORATION, TOKYO (JP)

(72) Inventors: TADASHI YAMAGUCHI, TOKYO (JP); SATORU ISHII, TOKYO (JP)

(21) Appl. No.: 17/911,370

(22) PCT Filed: Mar. 9, 2021
(86) PCT No.: PCT/JP2021/009143

§ 371 Date: Sep. 13, 2022

(30) Foreign Application Priority Data
Mar. 23, 2020 (JP) 2020-051454

(51) Int. Cl. G10L 15/22; G10L 25/63; H04N 5/232

(52) U.S. Cl. CPC G10L 15/22; G10L 25/63; H04N 5/23216; G10L 2015/223

(57) ABSTRACT

The present technology relates to an information processing apparatus, an information processing method, and a program capable of performing a voice operation by a natural expression. An information processing apparatus according to the present technology includes a command processing unit that, in a case where a voice command that is input by a user and instructs to control a device includes a predetermined word for which a degree of control is determined as ambiguous, executes processing matching the voice command by using a parameter matching a way of speaking of a user at a time when the voice command is input. The present technology is applicable to, for example, an imaging apparatus that can be operated by a voice.

### TECHNICAL FIELD

The present technology relates to an information processing apparatus, an information processing method, and a program, and more particularly, relates to an information processing apparatus, an information processing method, and a program capable of performing a voice operation by a natural expression.

### BACKGROUND ART

In recent years, devices that can be operated by a voice have been increasing. For example, Patent Literature 1 discloses a television receiver in which a voice recognition device that analyzes user's speech contents is incorporated.

According to the television receiver disclosed in Patent Literature 1, the user can request presentation of certain information by a voice command, and view the presented information in response to the request.

### CITATION LIST

### Patent Document

Patent Document 1: Japanese Patent Application Laid-Open No. 2014-153663

### SUMMARY OF THE INVENTION

### Problems to be Solved by the Invention

In general, a person expresses a degree of a matter using ambiguous words such as “more” and “very” in a natural conversation.

In a case where a voice including such an ambiguous word is used as a voice command for a device in which the function of the voice UI is implemented, variations in the operation of the device increase. Therefore, it is difficult to use such an ambiguous word as a voice command.

The present technology has been made in view of such a situation, and enables a voice operation by a natural expression.

### Solutions to Problems

An information processing apparatus according to one aspect of the present technology includes a command processing unit that, in a case where a voice command that is input by a user and gives an instruction to control a device includes a predetermined word for which a degree of control is determined as ambiguous, executes processing matching the voice command by using a parameter matching a way of speaking of a user at a time when the voice command is input.

According to one aspect of the present technology, in a case where a voice command that is input by a user and gives an instruction to control a device includes a predetermined word for which a degree of control is determined as ambiguous, processing matching the voice command is executed by using a parameter matching a way of speaking of a user at a time when the voice command is input.

### BRIEF DESCRIPTION OF DRAWINGS

FIG. 1 is a view illustrating a usage example of an imaging apparatus according to an embodiment of the present technology.

FIG. 2 is a view illustrating an example of image processing according to a way of speaking of a user.

FIG. 3 is a block diagram illustrating a configuration example of the imaging apparatus.

FIG. 4 is a diagram illustrating an example of a way of speaking different from a usual way of speaking.

FIG. 5 is a flowchart illustrating image capturing processing.

FIG. 6 is a flowchart for describing image processing by a voice command performed in step S13 in FIG. 5.

FIG. 7 is a flowchart for describing semantic analysis processing of a voice command performed in step S33 in FIG. 6.

FIG. 8 is a block diagram illustrating a configuration example of an information processing apparatus to which the present technology is applied.

FIG. 9 is a block diagram illustrating a configuration example of hardware of a computer.

### MODE FOR CARRYING OUT THE INVENTION

An embodiment for carrying out the present technology will be described below. The description will be given in the following order.

1. Voice Operation Using Ambiguous Words

2. Configuration of Imaging Apparatus

3. Operation of Imaging Apparatus

4. Other Embodiment

5. About Computer

<1. Voice Operation Using Ambiguous Words>

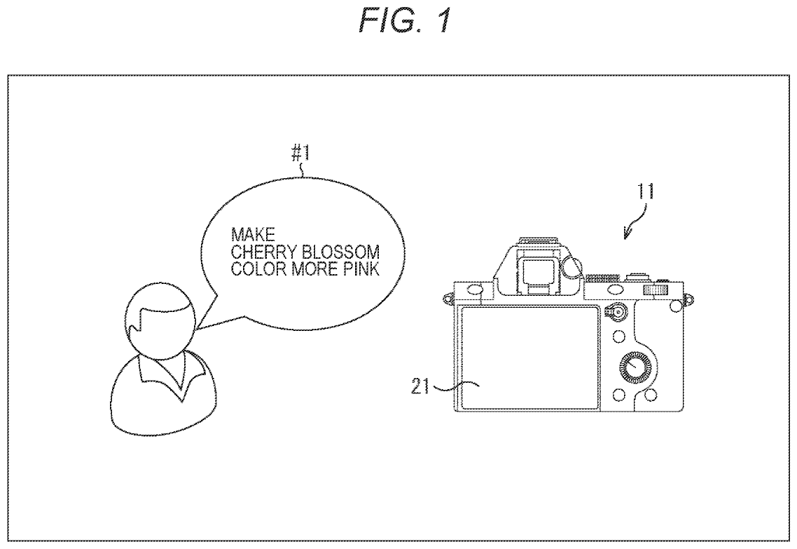

FIG. 1 is a view illustrating a usage example of an imaging apparatus 11 according to an embodiment of the present technology.

The imaging apparatus 11 is a camera that can be operated by a voice user interface (UI). The imaging apparatus 11 is provided with a microphone (not illustrated) for collecting the voice uttered by a user. The user can perform various operations such as setting of image capturing parameters by speaking to the imaging apparatus 11 and inputting a voice command. The voice command is information that gives an instruction on control of the imaging apparatus 11.

In the example of FIG. 1, the imaging apparatus 11 is a camera, yet another device having an imaging function such as smartphones, tablet terminals, or PCs can be also used as the imaging apparatus 11.

As illustrated in FIG. 1, a liquid crystal monitor 21 is provided on a back surface of a housing of the imaging apparatus 11. For example, before image capturing of a still image, the liquid crystal monitor 21 displays a live view image for displaying an image imported by the imaging apparatus 11 in real time. A user who is a person who capture images can perform an image capturing operation using a voice command while checking an angle of view, a color tone, and the like by viewing the live view image displayed on the liquid crystal monitor 21.

In a case where, for example, the user speaks “make cherry blossom color more pink” as illustrated in a bubble #1, the imaging apparatus 11 performs voice recognition and semantic analysis, and performs image processing of adjusting a color tone of the cherry blossom shown in an image to pink in response to the speaking of the user.

In general, a person expresses a degree using ambiguous words such as “more” and “very” in a natural conversation. Since an ambiguous word is a non-quantitative word whose degree of expression varies depending on a person, in a case where a voice command including such a word is input, the operation of the device usually varies significantly.

The imaging apparatus 11 in FIG. 1 designates words such as “more” and “very” whose degree of control is non-quantitative in advance as ambiguity designation words. In a case where the voice command includes the ambiguity designation word, the imaging apparatus 11 performs image processing by using a parameter set according to a way of speaking of the user at a time when the voice command is input.

In a case where, for example, a usual way of speaking is set as a reference way of speaking, image processing is performed by using a parameter set on the basis of a difference between the way of speaking of the user at a time when the voice command is input and the usual way of speaking. In this manner, the imaging apparatus 11 functions as an information processing apparatus that performs image processing by using the parameter set according to the way of speaking of the user at a time when the voice command is input.

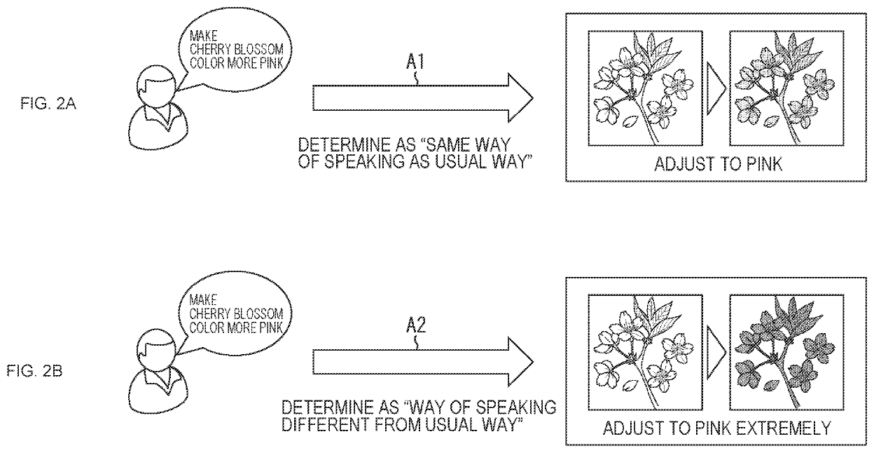

FIG. 2 is a diagram illustrating an example of image processing matching the way of speaking of the user.

The image processing illustrated in FIG. 2 is processing in a case where the user speaks “make cherry blossom color more pink”, that is, in a case where a voice command for adjusting the color is input. The voice command input by the user includes “more” that is the ambiguity designation word.

In a case where the voice command for adjusting the color is input, the imaging apparatus 11 determines whether or not the way of speaking of the user at a time when the voice command is input is different from the usual way of speaking.

In a case where, for example, it is determined that the way of speaking of the user is the same way of speaking as the usual way of speaking as indicated by A in FIG. 2, the imaging apparatus 11 adjusts the color tone of the cherry blossom shown in the image to pink by a predetermined degree according to the voice command as indicated by a tip of an arrow A1. In A in FIG. 2, that a light color is applied to the cherry blossom indicates that the color tone of the cherry blossom shown in the image is adjusted to pink by the predetermined degree.

On the other hand, in a case where it is determined that the way of speaking of the user is a way of speaking different from the usual way of speaking as illustrated in B in FIG. 2, the imaging apparatus 11 adjusts the color tone of the cherry blossom shown in the image to pink extremely according to the voice command as indicated by the tip of an arrow A2.

That is, in a case where the way of speaking of the user is different from the usual way of speaking, the imaging apparatus 11 adjusts the color tone by an adjustment amount larger than an adjustment amount in a case where the way of speaking of the user is the same as the usual way of speaking. In B in FIG. 2, that a dark color is applied to the cherry blossom indicates that the color tone of the cherry blossom shown in the image is adjusted to pink extremely.

As described above, the imaging apparatus 11 sets the parameter that indicates the degree of image processing according to whether or not the way of speaking of the user at the time when the voice command is input is different from the usual way of speaking. It is possible to similarly adjust not only the color tone of an image, but also the degree of other settings such as a frame rate, a blur quantity, and a brightness by using the voice command including the ambiguity designation word.

Therefore, the user who is the person who captures images can operate the imaging apparatus 11 by a voice including a natural expression that uses ambiguous words such as “more” and “very” as if making an instruction to a person of a camera assistant.

When adjusting the parameter related to image capturing while viewing the operation of the imaging apparatus 11, the user can adjust the parameter without specifically designating a numerical value, and thus easily perform the operation.

The user can feel free to use voice commands related to adjustment of sensuous expressions such as a color tone, a frame rate, a degree of blurring, and lightness (brightness).

<2. Configuration of Imaging Apparatus>

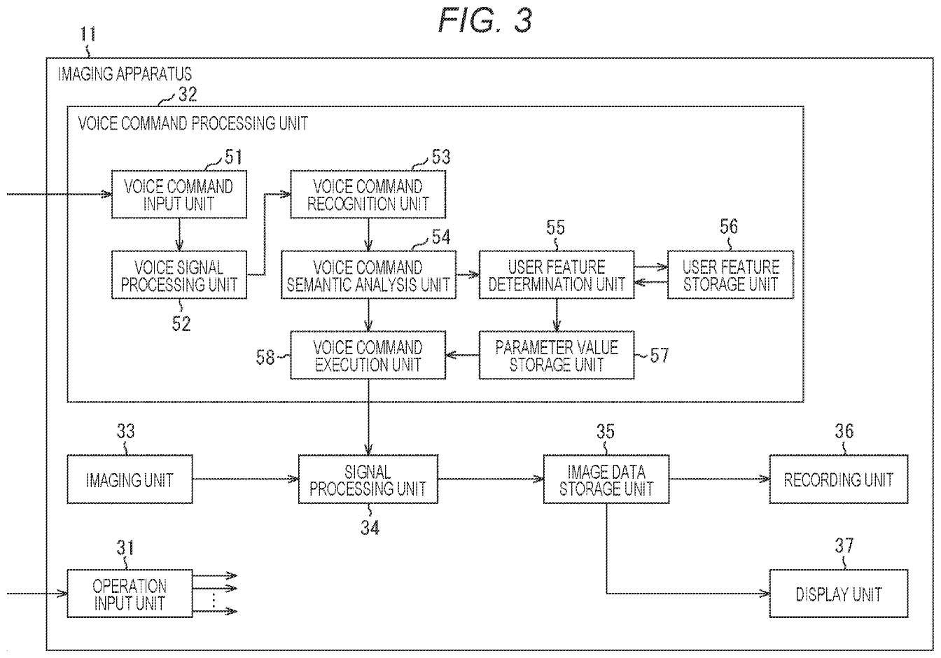

FIG. 3 is a block diagram illustrating a configuration example of the imaging apparatus 11.

As illustrated in FIG. 3, the imaging apparatus 11 includes an operation input unit 31, a voice command processing unit 32, an imaging unit 33, a signal processing unit 34, an image data storage unit 35, a recording unit 36, and a display unit 37.

The operation input unit 31 includes a button, a touch panel monitor, a controller, and a remote operation unit. The operation input unit 31 detects a user's camera operation, and outputs an operation instruction indicating contents of the detected camera operation. The operation instruction output from the operation input unit 31 is appropriately supplied to each component of the imaging apparatus 11.

The voice command processing unit 32 includes a voice command input unit 51, a voice signal processing unit 52, a voice command recognition unit 53, a voice command semantic analysis unit 54, a user feature determination unit 55, a user feature storage unit 56, a parameter value storage unit 57, and a voice command execution unit 58.

The voice command input unit 51 includes a sound collecting device such as a microphone. The voice command input unit 51 collects a voice uttered by the user, and outputs a voice signal to the voice signal processing unit 52.

Note that a microphone different from the microphone mounted on the imaging apparatus 11 may collect the voice uttered by the user. An external device connected to the imaging apparatus 11 such as a pin microphone or a microphone provided in another device can collect a voice uttered by the user.

The voice signal processing unit 52 performs signal processing such as noise reduction on the voice signal supplied from the voice command input unit 51, and outputs the voice signal after the signal processing to the voice command recognition unit 53.

The voice command recognition unit 53 performs voice recognition on the voice signal supplied from the voice signal processing unit 52, and detects a voice command. The voice command recognition unit 53 outputs a detection result of the voice command and the voice signal to the voice command semantic analysis unit 54.

The voice command semantic analysis unit 54 performs semantic analysis on the voice command detected by the voice command recognition unit 53, and determines whether or not the voice command input by the user includes an ambiguity designation word.

In a case where the voice command includes the ambiguity designation word, the voice command semantic analysis unit 54 outputs an analysis result of a meaning of the voice command and the voice signal supplied from the voice command recognition unit 53 to the user feature determination unit 55. Furthermore, the voice command semantic analysis unit 54 outputs the analysis result of the meaning of the voice command to the voice command execution unit 58.

Instead of determining whether or not the ambiguity designation word itself is included in the voice command, whether or not a word similar to the ambiguity designation word is included in the voice command may be determined. In a case where, for example, “more” is designated as the ambiguity designation word, words such as “a little more” and “a bit more” are determined as words similar to the ambiguity designation word.

In a case where a word similar to the ambiguity designation word is included in the voice command, processing similar to processing in a case where the ambiguity designation word is included in the voice command is performed by each unit.

As described above, the voice command semantic analysis unit 54 determines whether or not a predetermined word that includes the ambiguity designation word and a word similar to the ambiguity designation word and whose degree of control is ambiguous is included in the voice command.

The user feature determination unit 55 analyzes the voice signal supplied from the voice command semantic analysis unit 54, and extracts a feature amount. Furthermore, the user feature determination unit 55 reads the feature amount of the reference voice signal from the user feature storage unit 56. The user feature storage unit 56 stores, for example, the feature amount of the voice signal of the usual way of speaking of the user as the feature amount of the reference voice signal.

The user feature determination unit 55 compares the feature amount of the voice signal supplied from the voice command semantic analysis unit 54 and the feature amount of the reference voice signal, and determines whether or not the way of speaking of the user at a time when the voice command is input is a way of speaking different from the usual way of speaking.

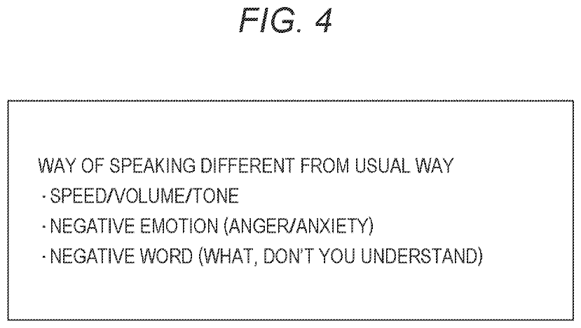

FIG. 4 is a view illustrating an example of a way of speaking different from a usual way of speaking.

The way of speaking is specified by, for example, a voice tone, an emotion, and wording. The user feature determination unit 55 determines whether or not the voice tone, the emotion, and the wording at the time when the voice command is input are different from a usual voice tone, emotion, and wording.

Instead of using all of the voice tone, the emotion, and the wording, the way of speaking may be specified on the basis of at least one of the voice tone, the emotion, or the wording. The way of speaking may be specified on the basis of other elements such as a user's facial expression and attitude.

The voice tone is specified on the basis of, for example, a speed, a volume, and a tone of the voice. In a case where the speed of the voice is different from a reference speed, in a case where the volume of the voice is different from a reference volume, or in a case where the tone of the voice is different from a reference tone, it is determined that the way of speaking of the user is a way of speaking different from the usual way of speaking.

The voice tone may be specified on the basis of a pitch expressed by a frequency of the voice signal, or a sound tone expressed by a waveform of the voice signal.

The emotion is identified by estimating the emotion on the basis of the voice signal. In a case where it is specified that the user has a negative emotion such as anger or an anxiety, it is determined that the way of speaking of the user is a way of speaking different from the usual way of speaking. The user's emotion may be estimated on the basis of an image obtained by capturing an image of the state of the user at the time when the voice command is input.

The wording is specified on the basis of a result of semantic analysis. In a case where it is specified that the user is using negative wording such as “What” or “Don't you understand”, it is determined that the way of speaking of the user is a way of speaking different from the usual way of speaking.

The user feature determination unit 55 in FIG. 3 sets a parameter used to perform processing matching the voice command on the basis of such a determination result, and stores the setting value of the parameter in the parameter value storage unit 57. That is, the user feature determination unit 55 also functions as a parameter setting unit that sets the parameter, too.

Furthermore, the user feature determination unit 55 stores in the user feature storage unit 56 the feature amount of the voice signal supplied from the voice command semantic analysis unit 54.

The feature amount of the voice signal stored in the user feature storage unit 56 is used for determination at a time when a next voice command is input. As the feature amount stored in the user feature storage unit 56 increases, the accuracy of determination by the user feature determination unit 55 improves.

Note that the feature amount of every user may be stored in the user feature storage unit 56. In this case, the user logs in when the fingerprint is read at a timing such as a time of activation of the imaging apparatus 11, and determination is performed by using the feature amount prepared for the logged-in user.

The user feature storage unit 56 includes an internal memory. The user feature storage unit 56 stores a feature amount of a user's voice signal. The user feature storage unit 56 may be provided in a device such as a server device on a cloud outside the imaging apparatus 11.

Note that the user feature determination unit 55 may perform the determination not on the basis of the voice signal but on the basis of an image obtained by capturing an image of the user. In this case, the user feature storage unit 56 stores a feature amount of an image obtained by capturing the image of the state of the user during the usual way of speaking. The user feature determination unit 55 determines whether or not the way of speaking of the user at the time when the voice command is input is different from the usual way of speaking on the basis of an image obtained by capturing the image of the state of the user at the time when the voice command is input. Note that the image of the state of the user at the time when the voice command is input is captured by, for example, a front camera mounted on the imaging apparatus 11.

Furthermore, the user feature determination unit 55 may perform determination on the basis of the sensor data detected by the wearable sensor put on by the user. In this case, the user feature storage unit 56 stores the feature amount of the sensor data detected by the wearable sensor during the usual way of speaking. The user feature determination unit 55 determines whether or not the way of speaking of the user is different from the usual way of speaking on the basis of the sensor data detected at the time when the voice command is input.

The parameter value storage unit 57 stores the setting value of the parameter set by the user feature determination unit 55.

The voice command execution unit 58 reads the setting value of the parameter from the parameter value storage unit 57. The voice command execution unit 58 executes processing matching the voice command input by the user by using the parameter read from the parameter value storage unit 57 on the basis of the analysis result supplied from the voice command semantic analysis unit 54.

In a case where, for example, the voice command which indicates adjustment of the color tone of the image is input, the voice command execution unit 58 causes the signal processing unit 34 to perform image processing of adjusting the color tone of the image by using the parameter set by the user feature determination unit 55.

The imaging unit 33 is configured as an image sensor. The imaging unit 33 converts received light into an electric signal, and imports an image. The image imported by the imaging unit 33 is output to the signal processing unit 34.

The signal processing unit 34 performs various types of signal processing on the image supplied from the imaging unit 33 under control of the voice command execution unit 58. The signal processing unit 34 performs the various types of image processing such as noise reduction, correction processing, demosaic, and processing of adjusting how an image looks. The image subjected to the image processing is supplied to the image data storage unit 35.

The image data storage unit 35 is configured as a dynamic random access memory (DRAM) or a static random access memory (SRAM). The image data storage unit 35 temporarily stores images supplied from the signal processing unit 34. The image data storage unit 35 outputs an image to the recording unit 36 and the display unit 37 in response to a user's operation.

The recording unit 36 includes an internal memory or a memory card attached to the imaging apparatus 11. The recording unit 36 records the image supplied from the image data storage unit 35. The recording unit 36 may be provided in an external device such as an external hard disk drive (HDD) or a server device on a cloud.

The display unit 37 includes the liquid crystal monitor 21 and a viewfinder. The display unit 37 converts the image supplied from the image data storage unit 35 into an appropriate resolution, and displays the image.

<3. Operation of Imaging Apparatus>

Here, the operation of the imaging apparatus 11 employing the above configuration will be described.

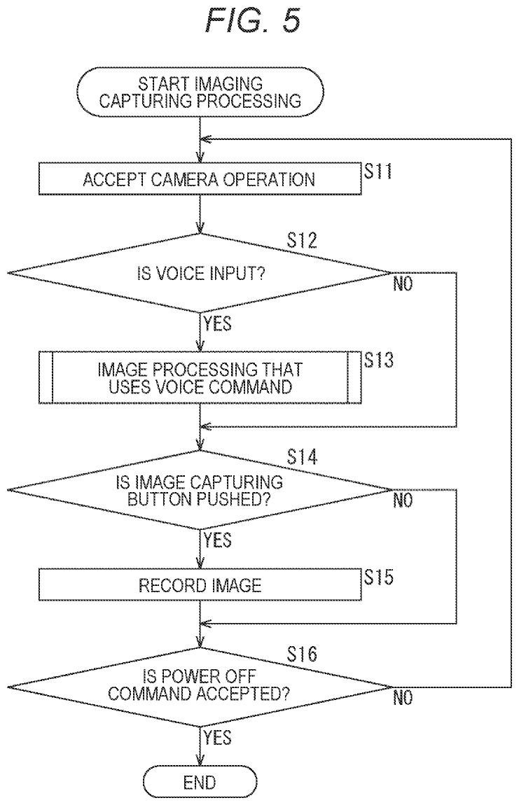

First, image capturing processing will be described with reference to the flowchart of FIG. 5. The image capturing processing in FIG. 5 is started in a case where, for example, the user inputs a power ON command to the operation input unit 31. At this time, the imaging unit 33 starts importing an image. The display unit 37 displays a live view image.

In step S11, the operation input unit 31 accepts a user's camera operation. For example, operations such as framing and camera setting are performed by the user.

In step S12, the voice command input unit 51 determines whether or not the user has input a voice.

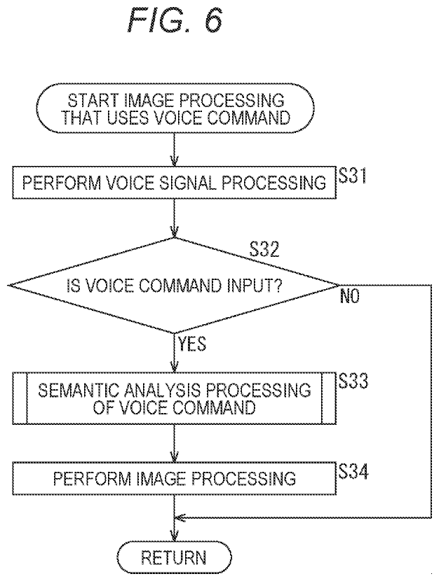

In a case where it is determined in step S12 that the voice has been input, the imaging apparatus 11 performs image processing that uses the voice command in step S13. Image processing that uses the voice command is performed by the image processing by the voice command. Details of the image processing that uses the voice command will be described later with reference to a flowchart of FIG. 6.

On the other hand, in a case where it is determined in step S12 that the voice command is not input, the processing in step S13 is skipped.

In step S14, the operation input unit 31 determines whether or not the image capturing button has been pushed.

In a case where it is determined in step S14 that the image capturing button has been pushed, the recording unit 36 records an image in step S15. The image captured by the imaging unit 33 and subjected to predetermined image processing by the signal processing unit 34 is supplied from the image data storage unit 35 to the recording unit 36 and recorded.

On the other hand, in a case where it is determined in step S14 that the image capture button is not pushed, the processing in step S15 is skipped.

In step S16, the operation input unit 31 determines whether or not a user's power OFF command has been accepted.

In a case where it is determined in step S16 that the power OFF command has not been accepted, the flow returns to step S11, and subsequent processing is performed. In a case where it is determined in step S16 that the power OFF command has been accepted, the processing ends.

Next, image processing that uses the voice command and is performed in step S13 in FIG. 5 will be described with reference to the flowchart of FIG. 6.

In step S31, the voice signal processing unit 52 performs voice signal processing on the voice signal that indicates the voice input by the user.

In step S32, the voice command recognition unit 53 determines whether or not the voice command has been input on the basis of the voice signal subjected to the voice signal processing.

In a case where, for example, a specific word that is a word for specifying a voice command is included in the voice signal, the voice command recognition unit 53 determines that the voice command has been input. Furthermore, in a case where the user inputs a voice while a predetermined button is pushed, the voice command recognition unit 53 determines that the voice command has been input.

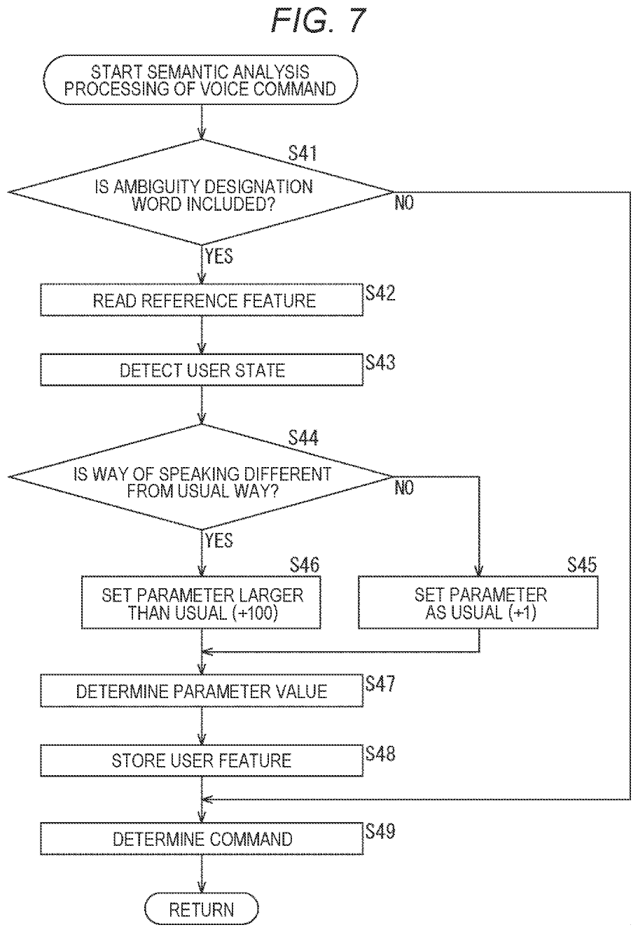

In a case where it is determined in step S32 that the voice command has been input, the voice command processing unit 32 performs semantic analysis processing of the voice command in step S33. A parameter for executing processing matching the voice command is determined by the semantic analysis processing of the voice command. Details of the semantic analysis processing of the voice command will be described later with reference to a flowchart in FIG. 7.

In step S34, the signal processing unit 34 performs image processing by using the parameter determined by the semantic analysis processing in step S33. After the image subjected to the image processing is stored in the image data storage unit 35, the flow returns to step S13 in FIG. 5, and subsequent processing is performed.

Similarly, in a case where it is determined in step S32 that the voice command is not input, the flow returns to step S13 in FIG. 5, and subsequent processing is performed.

Next, the semantic analysis processing of the voice command performed in step S33 in FIG. 6 will be described with reference to the flowchart of FIG. 7.

In step S41, the voice command semantic analysis unit 54 determines whether or not the voice command input by the user includes an ambiguity designation word.

In a case where it is determined in step S41 that the voice command includes the ambiguity designation word, the user feature determination unit 55 reads the feature amount of the reference voice signal from the user feature storage unit 56 in step S42. Furthermore, the user feature determination unit 55 analyzes a voice signal that indicates the voice input by the user, and extracts a feature amount.

In step S43, the user feature determination unit 55 compares the feature amount of the voice signal that indicates the voice input by the user, and the feature amount of the reference voice signal, and detects the user state on the basis of a difference between these feature amounts.

In step S44, the user feature determination unit 55 determines whether or not the way of speaking of the user is different from the usual way of speaking on the basis of the determination result of step S43.

In a case where, for example, the user is angry, it is determined that the way of speaking of the user is a way of speaking different from the usual way of speaking. On the basis of other user states in a case where the user is speaking fast or in a case where the user is depressed and has a negative emotion, whether or not the way of speaking of the user is different from the usual way of speaking may be determined.

In a case where it is determined in step S44 that the way of speaking of the user at the time when the voice command is input is the same as the usual way of speaking, the user feature determination unit 55 sets the parameter as usual in step S45. Specifically, the user feature determination unit 55 adjusts the current setting value by an adjustment amount set in advance to the ambiguity designation word, and sets the parameter. In a case where, for example, the ambiguity designation word “more” is included in the voice command, the user feature determination unit 55 adjusts the current setting value by +1, and sets the parameter.

On the other hand, in a case where it is determined in step S44 that the way of speaking of the user at the time when the voice command is input is different from the usual way of speaking, the user feature determination unit 55 sets a larger parameter larger than usual in step S46. Specifically, the user feature determination unit 55 adjusts the current setting value by a larger adjustment amount than the adjustment amount set in advance to the ambiguity designation word, and sets the parameter. In a case where, for example, the ambiguity designation word “more” is included in the voice command, the user feature determination unit 55 adjusts the current setting value by +100, and sets the parameter.

Note that the adjustment amount of the parameter may change according to a difference between the way of speaking of the user at the time when the voice command is input and the reference way of speaking.

In step S47, the user feature determination unit 55 determines the setting value of the parameter, and stores the setting value in the parameter value storage unit 57.

In step S48, the user feature determination unit 55 stores in the user feature storage unit 56 the feature amount of the voice signal that indicates the voice input by the user.

After the feature amount of the voice signal is stored in the user feature storage unit 56, or in a case where it is determined in step S41 that the voice command does not include the ambiguity designation word, the processing proceeds to step S49. In a case where the voice command does not include the ambiguity designation word, the parameter is not set according to the way of speaking of the user.

In step S49, the voice command execution unit 58 reads the setting value of the parameter from the parameter value storage unit 57, and sets the voice command together with the setting value of the parameter to the signal processing unit 34.

Thereafter, the flow returns to step S33 in FIG. 6, and subsequent processing is performed. The signal processing unit 34 performs the image processing matching the voice command by using the parameter set by the voice command execution unit 58.

Note that, in a case where a voice command for adjusting the same parameter is input again by the user after the semantic analysis processing in FIG. 7 is performed once, the adjustment amount at the time of setting of the parameter may be adjusted. The voice command for adjusting the same parameter is input again in a case where, for example, the user does not like the parameter set according to a previously input voice command.

In this case, the adjustment amount used in step S45 or step S46 is adjusted to be, for example, a larger adjustment amount. In a case where the adjustment amount of the parameter is adjusted, the imaging apparatus 11 is personalized according to the user's sense so to speak.

As described above, in a case where the voice input by the user includes an ambiguous word, the parameter is adjusted according to the way of speaking of the user, and processing matching the voice command is performed. The user can operate the imaging apparatus 11 by a voice including a natural expression that uses ambiguous words such as “more” and “very”.

<4. Other Embodiment>

Although the case where the image processing is performed by the voice including the ambiguity designation word has been mainly described, various types of control of the device such as control related to imaging, control related to display, and control related to communication may be performed according to the voice including the ambiguity designation word.

Although the operation that uses the voice including the ambiguity designation word is performed in the camera, the present technology can be applied to processing in an arbitrary device.

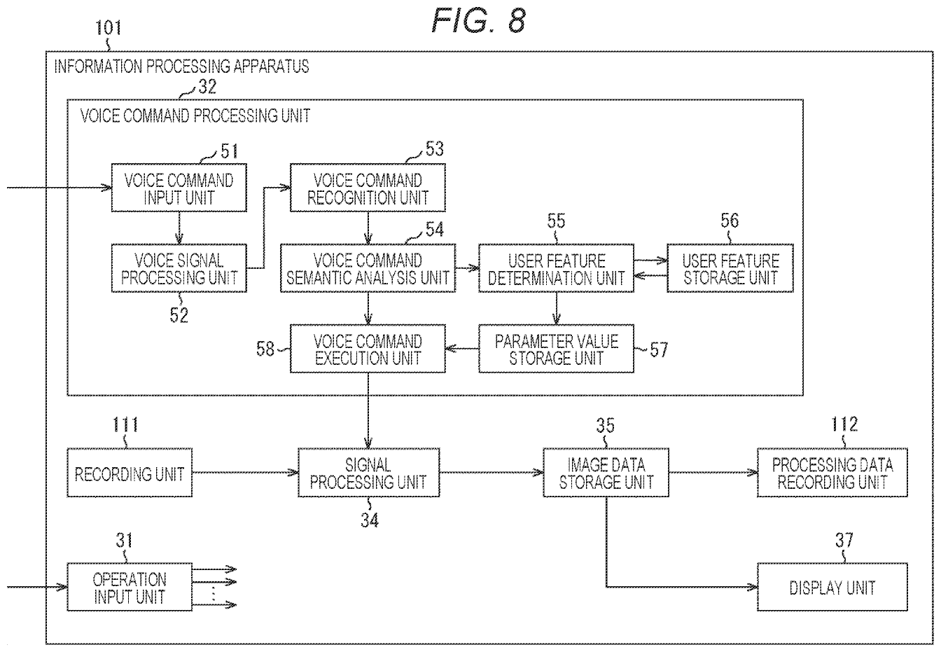

FIG. 8 is a block diagram illustrating a configuration example of an information processing apparatus 101 to which the present technology is applied.

The information processing apparatus 101 in FIG. 8 is, for example, a PC used to edit an image captured by a camera. As described above, the present technology is applicable not only to processing of a live view image in the camera, but also to processing in an apparatus that edits an image stored in a predetermined recording unit.

In FIG. 8, the same components as the components of the imaging apparatus 11 in FIG. 4 are denoted by the same reference numerals. Overlapping description will be omitted as appropriate.

The configuration of the information processing apparatus 101 illustrated in FIG. 8 is the same as the configuration of the imaging apparatus 11 described with reference to FIG. 4 except that a recording unit 111 and a processing data recording unit 112 are provided.

The recording unit 111 includes an internal memory or an external storage. The recording unit 111 records images captured by a camera such as the imaging apparatus 11.

The signal processing unit 34 reads an image from the recording unit 111, and performs image processing related to image editing under control of the voice command execution unit 58. An operation related to image editing is performed by a voice including the ambiguity designation word. The image subjected to the image processing by the signal processing unit 34 is output to the image data storage unit 35.

The image data storage unit 35 temporarily stores images supplied from the signal processing unit 34. The image data storage unit 35 supplies an image to the processing data recording unit 112 and the display unit 37 in response to a user's operation.

The processing data recording unit 112 includes an internal memory or an external storage. The processing data recording unit 112 records an image supplied from the image data storage unit 35.

The user can operate the information processing apparatus 101 by a voice including a natural expression that uses ambiguous words such as “more” and “very”, and cause the information processing apparatus 101 to perform image editing such as image processing.

<5. About Computer>

The above-described series of processing can be executed by hardware or can be executed by software. In a case where the series of processing is executed by software, a program that configures this software is installed to a computer incorporated in dedicated hardware or a general-purpose personal computer from a program recording medium.

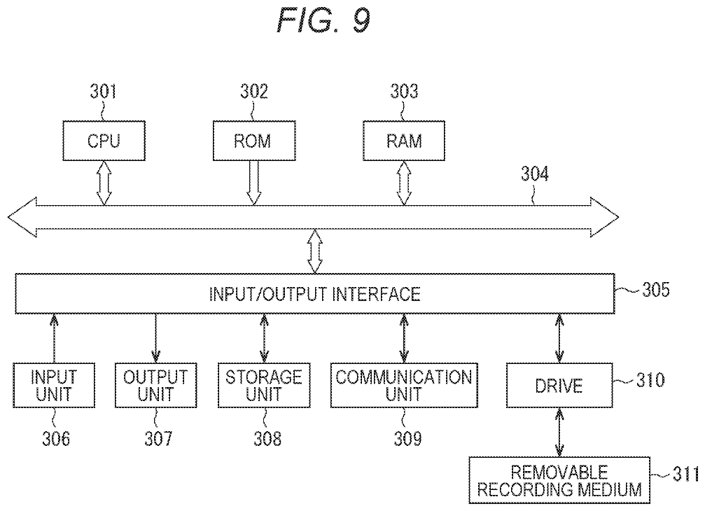

FIG. 9 is a block diagram illustrating a configuration example of hardware of a computer that executes the above-described series of processing by a program.

A central processing unit (CPU) 301, a read only memory (ROM) 302, and a random access memory (RAM) 303 are mutually connected by a bus 304.

The bus 304 is further connected with an input/output interface 305. The input/output interface 305 is connected with an input unit 306 including a keyboard and a mouse, and an output unit 307 including a display and a speaker. Furthermore, the input/output interface 305 is connected with a storage unit 308 that includes a hard disk or a nonvolatile memory, a communication unit 309 that includes a network interface, and a drive 310 that drives a removable medium 311.

In a case where, for example, the CPU 301 loads a program stored in the storage unit 308 into the RAM 303 via the input/output interface 305 and the bus 304 and executes the program, the computer configured as described above performs the above-described series of processing.

The program executed by the CPU 301 is recorded in, for example, the removable medium 311 or is provided via a wired or wireless transmission medium such as a local area network, the Internet, or digital broadcasting, and is installed in the storage unit 308.

Note that the program executed by the computer may be a program that performs processing in time series in order described in this description, or may be a program which performs processing in parallel or at a necessary timing such as a time when invoked.

The effects described in this description are merely examples and are not limited, and other effects may be provided.

The embodiment of the present technology is not limited to the above-described embodiment, and various modifications can be made without departing from the gist of the present technology.

For example, the present technology can employ a configuration of cloud computing where one function is shared and processed in cooperation by a plurality of devices via a network.

Furthermore, each step described with reference to the above-described flowchart can be executed by one device and, in addition, can be shared and executed by a plurality of devices.

Furthermore, in a case where a plurality of processing is included in one step, a plurality of processing included in this one step can be executed by one device and, in addition, can be shared and executed by a plurality of devices.

<Combination Example of Configuration>

The present technology can employ the following configurations, too.

(1)

An information processing apparatus including a command processing unit that, in a case where a voice command that is input by a user and gives an instruction to control a device includes a predetermined word for which a degree of control is determined as ambiguous, executes processing matching the voice command by using a parameter matching a way of speaking of the user at the time when the voice command is input.

(2)

The information processing apparatus described in above (1), in which

the command processing unit executes the control matching the voice command by using the parameter set on the basis of a difference between the way of speaking of the user at the time when the voice command is input and a reference way of speaking.

(3)

The information processing apparatus described in above (2), in which,

in a case where the way of speaking of the user at the time when the voice command is input is different from the reference way of speaking, the command processing unit sets the parameter adjusted to be larger than a reference parameter.

(4)

The information processing apparatus described in above (3) further including

a determination unit that determines whether or not the way of speaking of the user at the time when the voice command is input is a way of speaking different from the reference way of speaking.

(5)

The information processing apparatus described in above (4), in which

the determination unit determines whether or not the way of speaking of the user at the time when the voice command is input is a way of speaking different from the reference way of speaking on the basis of a feature amount of a voice including at least one of a speed, a volume, or a tone of the voice.

(6)

The information processing apparatus described in above (4), in which

the determination unit determines whether or not the way of speaking of the user at the time when the voice command is input is a way of speaking different from the reference way of speaking on the basis of an emotion of the user at the time when the voice command is input.

(7)

The information processing apparatus described in above (4), in which

the determination unit determines whether or not the way of speaking of the user at the time when the voice command is input is a way of speaking different from the reference way of speaking on the basis of wording of the user at the time when the voice command is input.

(8)

The information processing apparatus described in above (4), in which

the determination unit determines whether or not the way of speaking of the user at the time when the voice command is input is a way of speaking different from the reference way of speaking on the basis of an image captured and obtained by the user at the time when the voice command is input.

(9)

The information processing apparatus described in above (4), in which

the determination unit determines whether or not the way of speaking of the user at the time when the voice command is input is a way of speaking different from the reference way of speaking on the basis of sensor data of a wearable sensor put on by the user at the time when the voice command is input.

(10)

The information processing apparatus described in any one of above (1) to (9), in which

the voice command is a command related to image processing, and

the information processing apparatus further includes an image processing unit that performs the image processing matching the voice command by using the parameter.

(11)

The information processing apparatus described in above (10), in which

the parameter is information that indicates at least one of a color, a frame rate, a blur quantity, or a brightness.

(12)

The information processing apparatus described in above (10) or (11) further including

an imaging unit that performs imaging, in which

the image processing unit performs the image processing on an image captured by the imaging unit.

(13)

The information processing apparatus described in above (10) or (11), in which

the image processing unit performs the image processing on an image read from a predetermined recording unit.

(14)

An information processing method including,

at an information processing apparatus, in a case where a voice command that is input by a user and gives an instruction to control a device includes a predetermined word for which a degree of control is determined as ambiguous, executing processing matching the voice command by using a parameter matching a way of speaking of a user at a time when the voice command is input.

(15)

A program causes a computer to function as a command processing unit that, in a case where a voice command that is input by a user and instructs to control a device includes a predetermined word for which a degree of control is determined as ambiguous, executes processing matching the voice command by using a parameter matching a way of speaking of a user at a time when the voice command is input.

### REFERENCE SIGNS LIST

11 Imaging apparatus
31 Operation input unit
32 Voice command input unit
33 Imaging unit
34 Signal processing unit
35 Image data storage unit
36 Recording unit
37 Display unit
51 Voice command input unit
52 Voice signal processing unit
53 Voice command recognition unit
54 Voice command semantic analysis unit
55 User feature determination unit
56 User feature storage unit
57 Parameter value storage unit
58 Voice command execution unit
101 Information processing apparatus
111 Recording unit
112 Processing data recording unit

1. An information processing apparatus comprising
a command processing unit that, in a case where a voice command that is input by a user and gives an instruction to control a device includes a predetermined word for which a degree of control is determined as ambiguous, executes processing matching the voice command by using a parameter matching a way of speaking of the user at a time when the voice command is input.

2. The information processing apparatus according to claim 1, wherein
the command processing unit executes the control matching the voice command by using the parameter set on a basis of a difference between the way of speaking of the user at the time when the voice command is input and a reference way of speaking.

3. The information processing apparatus according to claim 2, wherein,
in a case where the way of speaking of the user at the time when the voice command is input is different from the reference way of speaking, the command processing unit sets the parameter adjusted to be larger than a reference parameter.

4. The information processing apparatus according to claim 3, further comprising
a determination unit that determines whether or not the way of speaking of the user at the time when the voice command is input is different from the reference way of speaking.

5. The information processing apparatus according to claim 4, wherein
the determination unit determines whether or not the way of speaking of the user at the time when the voice command is input is a way of speaking different from the reference way of speaking on a basis of a feature amount of a voice including at least one of a speed, a volume, or a tone of the voice.

6. The information processing apparatus according to claim 4, wherein
the determination unit determines whether or not the way of speaking of the user at the time when the voice command is input is a way of speaking different from the reference way of speaking on a basis of an emotion of the user at the time when the voice command is input.

7. The information processing apparatus according to claim 4, wherein
the determination unit determines whether or not the way of speaking of the user at the time when the voice command is input is a way of speaking different from the reference way of speaking on a basis of wording of the user at the time when the voice command is input.

8. The information processing apparatus according to claim 4, wherein
the determination unit determines whether or not the way of speaking of the user at the time when the voice command is input is a way of speaking different from the reference way of speaking on a basis of an image captured and obtained by the user at the time when the voice command is input.

9. The information processing apparatus according to claim 4, wherein
the determination unit determines whether or not the way of speaking of the user at the time when the voice command is input is a way of speaking different from the reference way of speaking on a basis of sensor data of a wearable sensor put on by the user at the time when the voice command is input.

10. The information processing apparatus according to claim 1, wherein
the voice command is a command related to image processing, and
the information processing apparatus further comprises an image processing unit that performs the image processing matching the voice command by using the parameter.

11. The information processing apparatus according to claim 10, wherein
the parameter is information that indicates at least one of a color, a frame rate, a blur quantity, or brightness.

12. The information processing apparatus according to claim 10, further comprising
an imaging unit that performs imaging, wherein
the image processing unit performs the image processing on an image captured by the imaging unit.

13. The information processing apparatus according to claim 10, wherein
the image processing unit performs the image processing on an image read from a predetermined recording unit.

14. An information processing method comprising,
at an information processing apparatus, in a case where a voice command that is input by a user and gives an instruction to control a device includes a predetermined word for which a degree of control is determined as ambiguous, executing processing matching the voice command by using a parameter matching a way of speaking of the user at a time when the voice command is input.

15. A program causing a computer to function as
a command processing unit that, in a case where a voice command that is input by a user and gives an instruction to control a device includes a predetermined word for which a degree of control is determined as ambiguous, executes processing matching the voice command by using a parameter matching a way of speaking of the user at a time when the voice command is input.
